(19) United States
(12) Patent Application Publication
(10) Pub. No.: US 2006/0091252 A1
(43) Pub. Date: May 4, 2006

(54) Belt retractor for a vehicle safety belt system and vehicle safety belt system

(75) Inventors: Joachim Biller, Lorch (DE); Wolf-Dieter Hoenl, Boebingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/261,036

(22) Filed: Oct. 28, 2005

(30) Foreign Application Priority Data
Nov. 4, 2004 (DE) 10 2004 053 305.9

(51) Int. Cl. B60R 22/34

(52) U.S. Cl. 242/381

(57) ABSTRACT

A belt retractor for a vehicle safety belt system has a frame, a belt reel rotatably mounted in the frame, and a brake device. The brake device includes at least one first brake element and a brake disk rotatably disposed relative to the first brake element and has an adjusting disk rotatable with respect to the brake element. The brake device is designed such that a rotation of the adjusting disk causes a displacement of the first brake element, so that the brake element is caused to rest against the brake disk.

The invention relates to a belt retractor for a vehicle safety belt system.

### BACKGROUND OF THE INVENTION

It is the purpose of a safety belt to limit a forward movement of a vehicle occupant upon abrupt vehicle decelerations. To this end, the belt reel on which the belt webbing of the safety belt is wound up is blocked or locked.

A distinction may substantially be made here between two cases. On the one hand, there are the normal locking actions, e.g. in the case of a sharp braking maneuver. In such a case the locking of the belt reel has to be reversible, because such situations occur frequently. In this case the force, with which the vehicle occupant is restrained by the safety belt, is not too high, so that no further measures have to be taken.

It is a different case, when the vehicle is abruptly decelerated in an accident. Also now, the belt reel has to be locked so as to prevent the vehicle occupant from coming into contact with other vehicle parts. The forces occurring here may, however, be very high. Therefore, force limiters are used, in order to reduce the forces acting on the vehicle occupant. These force limiters permit a certain unwinding of the belt webbing and thus a certain forward movement of the vehicle occupant, whilst degrading the kinetic energy of the vehicle occupant.

Usually, different components are used for the locking of the belt reel and the force limitation. In the first case a locking pawl adapted to be pivoted into a toothing is mainly used, and in the second case a torsion bar is for example employed.

It is the object of the invention to provide a belt retractor that fulfils the modern safety requirements and requires only few components.

### BRIEF DESCRIPTION OF THE INVENTION

For this purpose there is provided in a belt retractor for a vehicle safety belt system a frame, a belt reel rotatably mounted in the frame, and a brake device which includes at least one first brake element and a brake disk rotatably disposed relative to the first brake element and which has an adjusting disk rotatable with respect to the brake element. The brake device is designed such that a rotation of the adjusting disk causes a displacement of the first brake element, so that the brake element is caused to rest against the brake disk. In accordance with the invention the blocking of the belt reel is achieved by the brake element or elements engaging the brake disk. Such a brake device may be operated in a simple manner with different brake forces. Therefore, the brake device and thus the belt retractor may flexibly be used on different situations that require a varying locking force of the belt reel. Apart from blocking the belt reel, the brake device may also assume the function of a force limiter, when the brake force is adjusted in such a manner that a rotation of the brake disk with respect to the brake elements is permitted when a predetermined first force threshold is exceeded, the kinetic energy of the vehicle occupant being degraded then by the friction between the brake elements and the brake disk. Apart from its force threshold that may flexibly be determined, the advantage of such a force limitation device is the option to employ the force limiter several times.

The brake disk is preferably connected non-rotatably to the belt reel, so that a direct force transmission from the brake device to the belt reel is achieved.

The first brake element may be disposed so as to be displaceable in an axial direction.

In a preferred embodiment of the invention there is provided at least one second brake element. Preferably, the first brake element and the second brake element engage opposite sides of the brake disk.

In particular in this arrangement it is advantageous, if the brake disk is disposed so as to be displaceable in an axial direction, because in this manner a constant brake force is automatically developed.

The brake elements may be disposed on a brake calliper that is preferably connected to the frame.

According to a preferred embodiment of the invention the adjusting disk comprises at least one wedge surface. By the wedge surface resting against one of the brake elements, a rotation of the adjusting disk may shift the brake element in the axial direction on account of the wedge shape of the contact surface.

Preferably, the first brake element comprises at least one wedge surface that is complementary to the wedge surface of the adjusting disk. By means of such a design a self-energizing of the braking effect may be achieved.

In order to increase the constancy of the braking effect, it is advantageous to configure at least one of the brake elements, preferably both brake elements, so as to be annular.

The brake force may easily be adjusted, if there is provided a drive unit rotating the adjusting disk. Preferably, the drive unit is an electric motor.

The invention also relates to a vehicle safety belt system comprising a belt retractor as described above and a control unit, and at least one sensor, the control unit actuating the drive unit for rotating the adjusting disk in response to sensor signals. In this manner the optimum brake force for blocking the belt reel or the force threshold for a force limitation may always be determined dependent on the respective situation.

The sensor may for example measure a belt webbing unwinding force. Sensors may also be provided for detecting dangerous driving situations (pre-crash situations), the evaluation of accident situations, or the measurement of the position and the weight of a vehicle occupant.

### BRIEF DESCRIPTION OF THE DRAWINGS

Further features and advantages of the invention will be apparent from the following description of an example of an embodiment in conjunction with the accompanying drawings, in which:

FIG. 1 shows a schematic view of a vehicle safety belt system in accordance with the invention including a belt retractor represented in section;

FIG. 2 shows a sectional view of the belt retractor of FIG. 1, as viewed along the line II-II in FIG. 3;

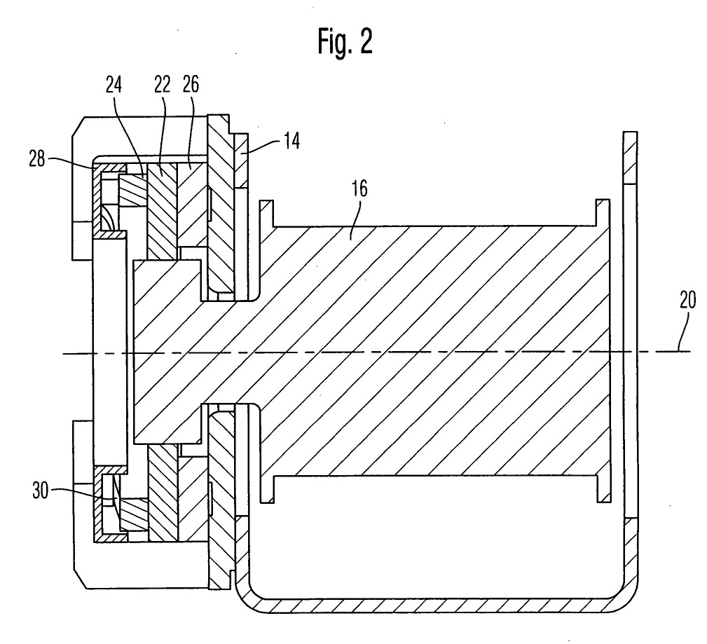

FIG. 3 shows a schematic side view of the belt retractor in accordance with the invention; and

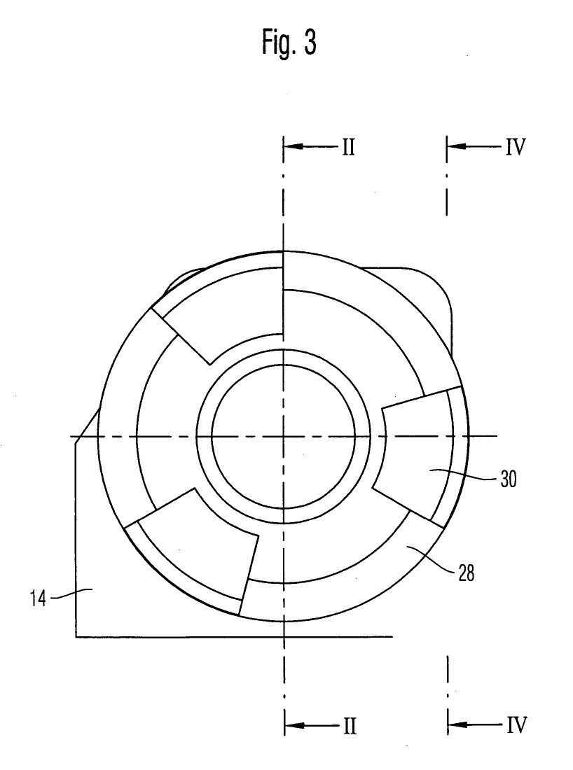

FIG. 4 shows a section along the line IV-IV of FIG. 3.

### DETAILED DESCRIPTION OF THE INVENTION

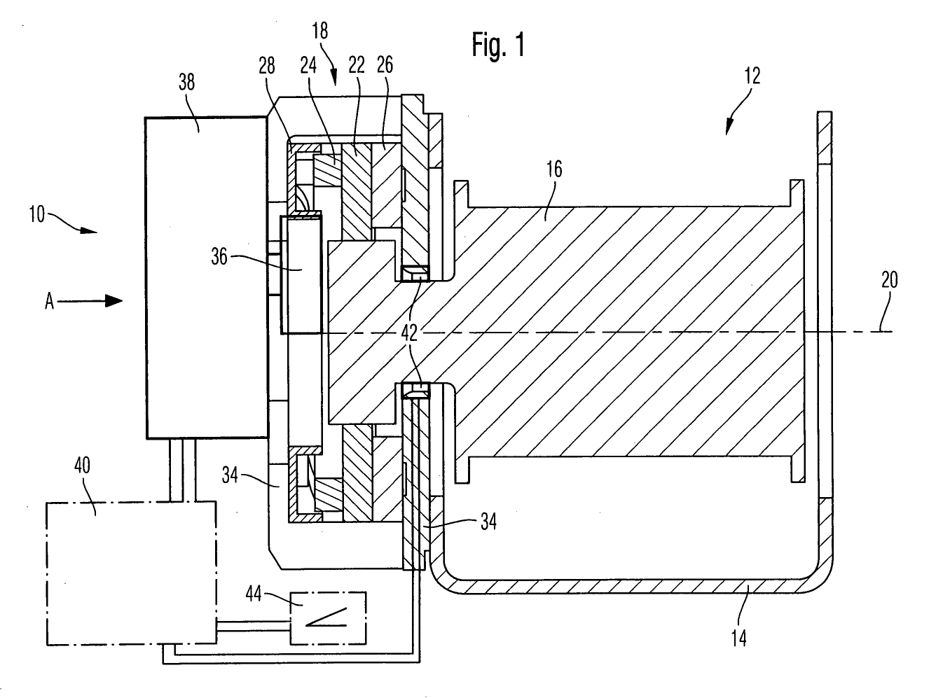

The vehicle safety belt system 10 as shown in FIG. 1 comprises a belt retractor 12 including a belt reel 16 which is rotatably mounted in a rigid frame 14 and on which a belt webbing not shown of a safety belt is received. The belt webbing may be unwound from the belt reel 16 or may be wound up thereon. The drive provided for this purpose is not shown and may be implemented in a known manner, for example via a retractor spring.

The blocking function for the belt reel 16 is assumed by a brake device 18 that is disposed on one side of the belt reel 16 at the frame 14.

An axis 20 of the belt reel 16 projects through the frame 14 on the side of the brake device 18 and carries an annular brake disk 22 that is disposed outside the frame 14. This annular brake disk 22 is connected to the axis 20 of the belt reel 16 so as to be non-rotatable therewith, but displaceable by a predetermined distance in the axial direction A. The brake disk 22 is a component which is separated in space from the belt reel 16 proper. Its thickness has only to be chosen to be so large as is required for stability purposes.

Disposed on the left and on the right of the brake disk 22 are a first brake element 24 and a second brake element 26 which are both annular. Both brake elements 24, 26 comprise a brake lining on the side facing towards the brake disk 22.

The second brake element 26 is non-rotatably fastened to the frame 14, whereas the first brake element 24 is displaceable in the axial direction A by a certain distance and mounted so as to be rotatable by a certain angular amount.

An adjusting disk 28 that is rotatably mounted is disposed adjoining the first brake element 24 in the axial direction A. This adjusting disk 28 includes a plurality of wedge surfaces 30 ascending in the circumferential direction. Complementary wedge surfaces 32 are provided on the side of the first brake element 24 facing towards the adjusting disk 28.

The brake disk 22, the two brake elements 24, 26, and the adjusting disk 28 are encompassed at their rims by a brake calliper 34.

The adjusting disk 28 communicates for example via a gear 36 with a drive unit 38, in this arrangement an electric motor that is disposed next to the adjusting disk 28 in the axial direction A. The drive unit 38 in turn is connected to a control unit 40 which also receives signals from various sensors 42, 44. In this arrangement, the sensors 42 are disposed between the axis 20 of the belt reel and the frame 14 and constantly measure a belt unwinding force. The sensors 44 may, for example, measure a vehicle acceleration. Any other sensors not represented here may further be provided.

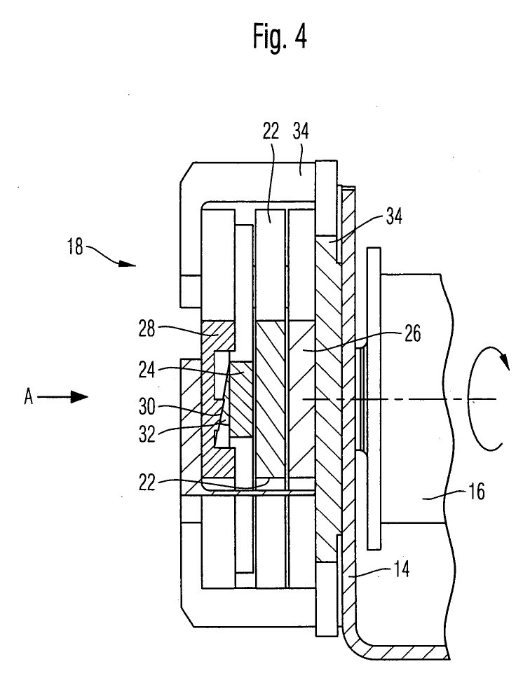

In the normal driving operation, the brake device 18 is in the state as shown in FIG. 4. The belt reel 16 is able to rotate freely, because both brake elements 24, 26 are spaced away from the brake disk 22. In this state, the brake elements 24, 26 and the brake disk 22 are biased by springs not shown.

Should a situation arise now, in which according to a decision by the control unit 40 the belt reel 16 is intended to be blocked, the drive unit 38 receives a corresponding signal and, as a result, rotates the adjusting disk 28 by a predetermined angle. By the wedge surfaces 30 of the adjusting disk 28 contacting the wedge surfaces 32 of the first brake element 24, the first brake element 24 is displaced in the axial direction A towards the brake disk 22, until it rests against the latter. The movement is imparted to the brake disk 22, and the latter likewise is displaced in the axial direction A, until it rests against the second brake element 26. Now, a brake force is imparted by both brake elements 24, 26 to the brake disk 22 and thus to the belt reel 16, whereby the belt reel 16 is decelerated.

The brake device 18 is designed so as to be self-energizing. By the first brake element 24 contacting the brake disk 22, the first brake element 24 is entrained in the direction of rotation of the belt reel 16 (see the arrow), because the first brake element 24 is able to rotate by a certain angular amount. Thereby, the wedge surfaces 32, 30 shift with respect to each other, whereby, since the wedge surface 30 is held in its position by the drive unit 38, the axial pressure in the direction A increases. The angular amount by which the first brake element 24 is able to rotate roughly corresponds to that taken up by the wedge surfaces 30, 32.

The sensors 42 that measure the belt unwinding force form, together with the control unit 40 and the drive unit 38, a control circuit. Via this control circuit, the position of the adjusting disk 28 is constantly monitored and corrected, if necessary.

According to the respective, prevailing circumstances and the respective situation a force threshold, up to which the belt reel 16 is completely blocked against rotation, may easily and flexibly be adjusted. This force threshold may be preset to a specific value, for example in response to sensors detecting the weight and the size of a vehicle occupant.

In the normal driving operation the force threshold is set to be relatively low. Here, the brake device 18 causes the normal locking or blocking of the belt reel 16, for example upon sharp decelerations. In the normal locking operation the force threshold may, for example, be between 2 and 4 kN.

However, should a very abrupt vehicle deceleration occur, e.g. within the context of an accident, the force threshold is set to a significantly higher value by the control unit 40 in response to the sensor signals. However, the force threshold is preferably only selected to be at such a value that when exceeding a predetermined belt webbing unwinding force that is constantly measured by the sensors 42 a rotation of the belt reel 16, and thus of the brake disk 22 with respect to the brake elements 24, 26, is possible, with belt webbing being unwound. Now, the brake device 18 acts as a force limiter, and the kinetic energy of the vehicle occupant is converted into friction between the brake disk 22 and the brake elements 24, 26. The force threshold, starting with which a force limitation takes effect, may again be selected dependent on the respective situation, for instance dependent on the seriousness of the accident or also on the weight and the position of the vehicle occupant. It may, for example, also be set to a higher value after a first or primary accident, in which a gas bag was activated, in order to keep the forward movement of the vehicle occupant smaller in the case of a subsequent accident, since now no gas bag is available any longer. As a preventive measure, the force threshold may also be set to a higher value in response to a signal of a pre-crash sensor indicating a potentially dangerous situation. Should no accident occur, the force threshold will again be lowered to the normal value.

Since both the normal locking function and the function of the force limiter are taken over by the brake device 18, the belt retractor according to the invention only has a minimal construction space.

In accordance with an embodiment not shown, it may also be provided that a brake element radially engages the brake disk.

In addition, a conventional blocking mechanism for the belt reel 16 may be provided, e.g. a locking pawl engaging into a locking toothing, in order to provide an emergency system for the case of a power failure.

1. A belt retractor for a vehicle safety belt system, comprising a frame, a belt reel rotatably mounted in said frame, and a brake device which includes a first brake element and a brake disk rotatably disposed relative to said brake element and which has an adjusting disk rotatable with respect to said brake element,
said brake device being designed such that a rotation of said adjusting disk causes a displacement of said brake element so that said brake element is caused to rest against said brake disk.

2. The belt retractor according to claim 1, characterized in that said brake disk is non-rotatably connected to said belt reel.

3. The belt retractor according to claim 1, characterized in that said first brake element is arranged so as to be displaceable in an axial direction.

4. The belt retractor according to claim 1, characterized in that there is provided a second brake element.

5. The belt retractor according to claim 4, characterized in that said first brake element and said second brake element engage opposite sides of said brake disk.

6. The belt retractor according to claim 1, characterized in that said brake disk is arranged so as to be displaceable in an axial direction.

7. The belt retractor according to claim 1, characterized in that said brake elements are arranged on a brake calliper.

8. The belt retractor according to claim 1, characterized in that said adjusting disk comprises a wedge surface.

9. The belt retractor according to claim 8, characterized in that said first brake element comprises a wedge surface that is complementary to said wedge surface of said adjusting disk.

10. The belt retractor according to claim 1, characterized in that at least one of said brake elements is annular.

11. The belt retractor according to claim 1, characterized in that there is provided a drive unit that is capable of rotating said adjusting disk.

12. The belt retractor according to claim 11, characterized in that said drive unit is an electric motor.

13. A vehicle safety belt system comprising a belt retractor according to claim 1, a control unit, and a sensor, said control unit actuating said drive unit for rotating said adjusting disk in response to signals from said sensor.

14. The vehicle safety belt system according to claim 13, characterized in that said sensor measures a belt webbing unwinding force.
